(19) United States
(12) Patent Application Publication
(10) Pub. No.: US 2011/0000403 A1
(43) Pub. Date: Jan. 6, 2011

(54) Stabilization of Milk of Lime Suspensions

(76) Inventors: Jean-Yves Tilquin, Villers-le-Boullet (BE); Pascal DiCroce, Louveigne (BE)

Correspondence Address: KRATZ, QUINTOS & HANSON, LLP, Greater Beneficial Union of Pittsburgh Building, 4232 Brownsville Road Suite308, Pittsburgh, PA, 15227, US

(21) Appl. No.: 12/225,286

(22) PCT Filed: Mar. 26, 2007
(86) PCT No.: PCT/EP2007/052845

§ 371 Date: Sep. 17, 2010

(30) Foreign Application Priority Data
Mar. 27, 2006 (EP) 06111736.2

(51) Int. Cl. C04B 2/02; C04B 2/06

(52) U.S. Cl. 106/795

(57) ABSTRACT

Limestone lime and/or magnesium lime milk of lime suspensions having a stable viscosity are prepared by adding to such suspensions glucides such as monosaccharides, disaccharides, oligosacchrides or derivatives of glucides obtained by oxidation or hydrogenation.

### BACKGROUND OF THE INVENTION

This invention relates to a method meant to stabilize the milks of lime that are naturally unstable. Milk of lime is defined as a colloidal suspension of colloidal alkaline earth hydroxide with 1 to 60% dry matter in the liquid. This suspension is obtained either by extinction of quick lime CaO or of dolomitic lime (Ca, Mg)O with a large excess of liquid, or by mixing calcium hydroxide Ca(OH)₂ (hydrated lime, calcium hydrate) or hydrated dolomitic lime in a liquid, or by diluting calcium hydroxide or lime paste. The liquid is generally water. The raw materials naturally contain impurities such as e.g. silica, alumina, iron oxide in small percentages.

Milk of lime is used in a varied amount of applications as chemical reagent, e.g. in waste water treatment, in construction, in acid fumes treatment.

The suspension is characterized by a dry (or solid) matter concentration and by a distribution of the size of the particles in suspension (grade distribution). Reactivity, sedimentation and viscosity are specifications of the milk of lime that are directly influenced by its concentration of dry matter and by its grade.

The reactivity of the milk of lime (or solubility index) is defined as the chemical availability of the particles in suspension, i.e. their solubility speed, the marker of which is the conductivity of the liquid phase. As a general rule, the smaller the size of the particles, the higher the reactivity of the milk of lime (however lower in value). A milk of lime with small size particles in suspension will be reactive.

Milk of lime is composed of individual particles of calcium hydroxide that tend to settle. This propensity is stronger as the size of the particles in suspension is larger and as the concentration of the solid matter is higher. Milk of lime prepared from reactive lime only shows limited sedimentation. Besides these parameters, the porosity of the lime and/or hydrate grains as well as the electrostatic charges of the particles play a role in the sedimentation.

The viscosity or rheological properties of the milks of lime is an intrinsic characteristic influenced by their concentrations of dry matters. Milks of lime with a concentration of dry matters below 20% behave as Newtonian fluids. The definition of a Newtonian fluid is rather restrictive: the shearing stress is proportionate to the speed gradient.

Any deviation from these rules points to a non-Newtonian behaviour, which can be experimentally observed on milks of lime with dry matter concentrations exceeding 20%. These suspensions have a non-ideal plastic Bingham type of fluid behaviour, i.e. these bodies show an elastic state when the shearing stress is below a critical value (called shearing or stress yield point). This body becomes plastic when the exceeding the shearing yield point. This property is generally linked to the existence of a rather rigid three-dimensional structure that will break only if the exerted force is high enough.

In practical terms, if the stress applied to the fluid is below the yield point, there will be no deformation, the fluid does not flow. A minimum stress is required to cause it to flow.

Furthermore, other rheological and sometimes irreversible effects have been evidenced. They can be explained either by the break away of ultra fine elements sticking to coarser particles, or by the variation in the homogeneity of the suspension. The rarely reversible time related rheological modifications in the suspensions generally result from variations in the specific surface area, in the crystal system of Ca(OH)₂, in the sedimentation of the large particles, etc.

The problem at hand concerns the viscosity and the stability. The viscosity of milk of lime is fundamental for its application, use and handling: preparation, conditioning, transportation, flowing and pumping. The related literature mentions “pumpable” suspensions. Their level of viscosity has to be such that their agitation (maintaining the suspension to avoid settling, re-homogenisation, bring it back in the state of a suspension) and its transportation (in pipes, pumping) be possible. Experimentally, this pumping ability is met when the dynamic viscosity of the suspension is below 1,500 cP (viscosity in centipoises, measured at a shearing speed of 5 s⁻¹). Some parameters depend on the dimensions of the installations (tanks, stirring devices, piping, pumps, . . . ). As a general rule, the viscosity of the milks of lime increases with the increase of the amount of dry material, with the decrease of the particulate size in the suspension, with the increase of the specific surface area of the raw materials. It is difficult to prepare concentrated milks of lime (e.g. with a dry matter concentration exceeding 30%) with a low viscosity and with a low particulate size.

Furthermore, some milks of lime are not naturally stable in time. The instability of the suspension is revealed by an important increase in their viscosity, in their shearing yield point and in their plastic viscosity. The aging phase of the suspensions occurs either in stationary conditions (at rest), or in dynamic conditions (stirring or shearing phase), or in mix conditions (alternated rest and agitation conditions). Aging phases of suspensions reflect the common industrial practices (encompassing production, storing, transportation, pumping and re-transportation phases, etc.). Dynamic aging avoids settling which would be harmful to the optimal use of the product. These rheological properties are all the more increased in time as the shearing stress and the concentration of the dry matter increase. They are dependent on the very nature of the raw material as well as on the fineness of the milks of lime: the coarser ones are stable, the finer ones less. This time related dependence of the rheological properties of the Ca(OH)₂ suspensions has been pointed out by some in related literature. Others stress the important increase in viscosity of Ca(OH)₂ suspensions depending on how their aging conditions: at rest or in shearing stress conditions.

The change in the rheological properties in the milks of lime generates numerous disadvantages:
impossibility to stir them and to transport them under conditions of increased dynamic viscosity, shearing yield point and plastic viscosity;
damages to equipment (piping, pump, mobile stirring device, motor), premature wearing of stirring devices;
request of specific equipment (adequate piping, powerful motor, efficient pump);
important energy costs (high shearing value, important motor and pump power).

These elements may impair their use, handling, storing . . . and disadvantage the producer as well as the final user. It is therefore crucial to find a solution to this stability problem

There are some documents on the viscosity reduction and/or on the anti-settling aspect. They report on the reduction of the viscosity of concentrated Ca(OH)₂ suspensions based on a choice of raw material or on the addition of additives such as dispersing agent, viscosity reducers, anti-settling products or crushing agents.

Further to this, it was suggested to use particles of raw material having, before being put in suspension, a specific surface area (BET method) below or equal to 10 m²/g, to achieve an aqueous magnesium-lime suspension that is concentrated and of limited viscosity. The viscosity aspects are analyzed, but the aspects regarding static, dynamic or mixed aging are not being envisaged. This document does not cite or state anything about the stability of suspensions.

Acrylic, methacrylic and 2-acrylamido-2-methylsulfonic acids are sometimes described as dispersing agents for pigments including kaolin, dolomite, titan dioxide, clay or chalk. This document does not cite or state anything about the stability of suspensions.

Other agents such as amphoteres and cationic polyelectrolytes with nitrogen groups (polyamines, polymers of diallyl ammonium dimethyl chloride), hectorite or other dispersing agents (polymethacrylates, polyphosphates) maintain the Ca(OH)₂ suspensions at a viscosity level that allow them to be pumped. Other types of dispersing agents are made of polyelectrolytes of low average molecular weight, such as, for example, acrylic and methacrylic acid polymers, the lignosulfonates. These agents enhance the fluidity of the concentrated Ca(OH)₂ suspension, but they provoke a brutal and uncontrollable increase in viscosity. These documents do not cite or state anything about the stability of suspensions.

Concentrated and fluid milks of lime are obtained by adding sulphur products (mainly gypsum) that limit the rise in temperature and favour the growth of the grains during lime hydration. These agents lead to the formation of more agglomerated particles. The resulting milks of lime have a limited reactivity and will strongly tend to settle. This document does not cite or state anything about the stability of suspensions.

A stable colloidal suspension of lime in a potassium hydroxide solution (with preferentially potassium chloride) is sometimes described, but this reference does not cite or suggest anything about the stability of the suspensions.

The addition of sodium silicate, bentonite or polyacrylate has been described as agents to stabilize Ca(OH)₂ suspensions as a way to avoid settling. This document however does not cite or state anything about the stability of suspensions within a wider framework.

Other families of dispersing agents have been described, such as derivates of polysaccharides soluble in water (such as partially hydrolysed cellulose containing carboxyl groups and, as an option to hyroxialkyle and/or sulfonate groups, partially hydrolysed starch containing a large proportion of amyloses and sulfoalkyle groups with 1 to 4 atoms of carbon). These additives have a low viscosity and a plastifying power on mineral suspensions including cement, lime or plaster. This document does not cite or state anything about the stability of suspensions.

It was demonstrated that fructose and some mono- and disaccharides could reduce the viscosity of aqueous suspensions of alumina (Al₂O₃), but this does not suggest that these additives can enhance the stability of suspensions, specifically the stability of milks of lime.

Others describe the fabrication of fluid suspensions containing calcium oxide, aluminium oxide and silica by adding sucrose, raffinose, lignine, methyl glucopyranoside, lactose, fructose, polyphosphate sodium, or trehalose. This document does not cite or state anything about the stability of suspensions.

None of the proposed solutions are adequate to maintain the stability of the milks of lime suspension over time, and more specifically for suspension with a high concentration of dry matter and for all conditions encountered in the industrial environments.

Some documents mention a solution to the stability problem by adding polyacrylates. They solve the stability problem of milks of lime by introducing polyacrylates in the ingredients as additives that mainly act as dispersing agents. These polyacrylates allow to obtain milks of lime with a high content of dry matter and reduced viscosity.

The EP 0313483 document thus mentions several polyacrylates (hydro soluble ethylene polymer and/or copolymer) that, when added at a rate of 500 to 20,000 ppm as crushing agents, allow the preparation of aqueous solutions of micro particulate lime with a high concentration of dry matter, with low and stable viscosities and with particles of the expected size and highly enhanced reactivity. It has to be noted that this additive can only be added during the crushing stage and that the aim of this additive is furthermore to enhance the reactivity of lime.

Some modified polyacrylates (500 to 100,000 ppm) increase the consistency of the suspensions and stabilize the suspension in time at the state of phase separation by settling. They allow the solutions to be pourable, even after some aging at rest, because they make them less susceptible to form non-fluid gels or dense sediments at a stationary stage.

Some describe the use of acid polymers such as polyacrylic/polyacrylate acids or polycarboxylic/polycarboxylate acids and of co-additives such as salts of alkaline metals or carboxylic and carboxylate acids with 2 to 10 atoms of carbon, which allow to prepare Ca(OH)₂ suspensions with low viscosities and that remain fluid after several days.

The addition of alkaline or alkaline earth polyacrylates (100 to 50,000 ppm) is also described. The aim of this addition is to achieve dispersion of hydrated lime that remains stable in time. This addition increases the quantity of dry matter in the Ca(OH)₂ suspensions and maintains a flow limit below 25, 1 Pa for a sampling period of 120 min. The shearing yield increases at rest conditions.

Calcium hydroxide suspensions are mentioned containing anionic and/or polycarboxylic acid salts types of flocculation agents. These suspensions show a good viscosity and are stable regarding settling.

Other documents address the same problem by using, in the ingredients of milks of lime with a concentration of at least 40% solid matter, agents including cationic and amphotere polyelectrolytes with groups containing nitrogen, as for example polyamines and polymers such as diallyl ammonium chloride. This composition can be completed by polyacrylates, polymethacrylates and polyphosphates. These agents maintain the suspensions at a pumpable viscosity but act as flocculants when dissolved in the suspensions.

In general, the polyacrylates are expensive chemical agents. They are furthermore incompatible with some applications, especially in food. Moreover, their biodegradable properties are insufficient.

### OBJECT OF THE INVENTION

An object of this invention is to turn naturally unstable milks of lime into stable solutions. Stable means that especially the rheological properties are maintained in time (such as dynamic viscosity, shearing yield or plastic viscosity) at levels compatible with their utilisation, implementation, optimal handling in time in stationary, dynamic or mixed conditions. After these aging phases, these properties have to show limited alteration. According to this invention, this aim is achieved in a milk of lime by the addition of one or several additives chosen among glucides or some of their derivates, such as the ones obtained by oxidation or by hydrogenation of these glucides. More generally, we will make reference to the viscosity of milks of lime.

### DESCRIPTION OF THE INVENTION

The milks of lime described in the present invention are suspensions with a content of dry matter between 1 and 60%, preferably between 10 and 50%, and best between 30 and 45%. These milks of lime are prepared according to different methods:
1. by extinction of calcic lime and/or dolomitic lime;
2. as from hydrated lime and/or hydrated dolomitic lime in powder;
3. by dilution of calcium and/or magnesium hydrate paste or calcic and/or dolomitic lime paste.

These raw materials naturally contain impurities (silica, alumina, . . . ). The liquid used for the suspension is usually water. Other non aqueous solvents can be envisaged as well as mixes of solvents.

The solid matter particles in alkaline earth hydroxide suspension are of the following general formulae: xCa(OH)₂.(1−x)MgO.yH₂O in which x and y are molar fractions and in which x is comprised between 0 and 1; x will preferably have a value between 0.8 and 1, and at best a value of 1.

It is preferable to have a milk of lime characterized by a fine size distribution to ensure a longer suspension of the particles and a better chemical reactivity. The suspension presents a distribution of particulate size x99 lower than 355 μm, preferably equal or below 250 μm, at best below 150 μm and a distribution X50 lower than 50 μm, preferably equal of below 30 μm, at best below 10 μm. The particulate size distribution is measured by laser diffraction. The distributions characterized by terms X99 and X50, are values interpolated on the particulate size distribution curve. The X99 and X50 distributions correspond to the dimensions for which respectively 99 and 50% of the particles are below the indicated dimensions. In order to adjust their size grades, these milks of lime can be submitted to crushing (for example by pearls), screening (e.g. on a cloth) or by any other size reduction means.

For all the other compositions described in this invention, the viscosity of the milks of lime are below 2000 cP (as measure with a Haake Rotovisco RT20 viscosimeter at a shearing speed of 5 s⁻¹), preferably below 1500 cP, at best below 1200 cP.

These additives are best selected among glucides or their derivates such as the ones obtained by oxidation of these glucides or by hydrogenation of these glucides, with the exclusion of glucide derivates esterified by an acid.

The additives described in this invention are glucides among which monosaccharides, disaccharides, oligosaccharides and polysaccharides.

Examples of monosaccharides: erythrose, threose, xylose, ribose, allose, glucose, galactose, fructose, mannose.

Examples of disaccharides: sucrose, lactose, maltose, trehalose.

Examples of polysaccharides: starch, modified starch, hydrolysed starch, glycogen, inuline, modified inuline, cellulose, modified cellulose, pectins, dextrins and cyclodextrins.

It has to be noted that some glucides such as inuline can be filed into oligosaccharides or polysaccharides, according to their effective degree of polymerisation.

Other molecules can be envisaged such as chitin, glucan, glycosaminoglucans, agar, pectin, xanthene gum, guar gum, carob, glucomannane.

Among these modified glucides, polyols in hydrogenated forms are taken into consideration. Examples: sorbitol (or glucitol), erythritol, xylitol, lactitol, maltitol.

Other modified glucides are the aminosaccharides such as glucosamine or oxided forms such as uronic acids (specifically galacturonic acid, glucuronic acid), gluconic acid, as well as the salts of these acids.

The sources taken into consideration for these additives are syrups and/or molasses derived from sugar cane, beats and chicory. These additives can also be selected among recycled material or production sub-products.

These additives can be conditioned in solid form, such as powder, in the form of a paste or as an aqueous or non-aqueous solution. They can be crystalline, semicrystalline or amorphous.

In the framework of this invention, these additives, used individually or mixed, are added to milks of lime at a rate of 0.01 to 10% in weight. This percentage is expressed in active matter weight of the additive compared to the total content of dry matter in the raw material requested to make the milk of lime. The values chosen will be preferably situated between 0.01 and 5%, at best between 0.1 and 1%.

This content will amongst other depend on the nature of the raw material, the concentration of dry matter, the aging conditions, etc. The concentration of the additive may need to be adjusted to meet the stability criteria of the rheology of the milk of lime. The milks of lime have to meet the specifications set by the producer and the customer as well as the utilisation conditions. This concentration also needs to be kept to a minimum for economic purposes.

The choice of one or several additives used as a mix can also be conditioned by the application. Some applications require strict specifications regarding food compatibility, respect of environmental regulations, process compatibility, etc. Other criteria, such as economic, availability, conditioning, user-friendly criteria can guide this choice.

These additives can be used alone or in formulation. The formulation consists in a mix of at least two additives selected within a same family or among several families. The formulation can be conditioned in solid form, or as a paste or an aqueous or non-aqueous solution.

In general, the additives in relation to this invention enter into the composition of milks of lime in different ways. The use of these additives does not prejudice the preparation of milks of lime and the advantage of the additives is that they addition can be adjustable. The additives can indeed be added at one stage or over several stages, in the course of different conditioning phases of the raw material or during the preparation of the milks of lime of the present invention.

As an example, these stages are the hydration stage or lime extinction, the lime and/or hydrate crushing phase, the milk of lime preparation stage, storing, transportation, etc. In detail, the preparation process of a milk of lime that is stable with regard to the evolution in time of the rheological properties, can be envisaged in stationary, dynamic or mixed conditions (by alternation of one or several stationary and dynamic phases). This process can thus develop as follows:
a. incorporation by mixing a solid additive or an aqueous or non-aqueous solution into a milk of lime that has been previously prepared with a content in lime or dolomitic lime hydrate of 1 to 60% in mass compared to the global mass of the milk of lime;
b. incorporation by mixing a solid additive or an aqueous or non-aqueous solution into the liquid preparation of the milk of lime and afterwards incorporation by mix of slaked lime in such a quantity that the resulting milk of lime shows a content in hydrated or dolomitic lime from 1 to 60% in weight compared to the global mass of the milk of lime;
c. incorporation by mixing a solid additive or an aqueous or non-aqueous solution into the milk of lime preparation liquid that will serve to hydrate the quicklime (CaO or dolomitic lime) and to slake the lime with this liquid in such a quantity that the resulting milk of lime shows a content of lime or dolomitic lime hydrate of 1 to 60% in weight compared to the global mass of the milk of lime;
d. the mix of a anhydrous dry hydrated lime (or dolomitic lime) with a solid additive and making a suspension with this mix in water in such a quantity that the resulting milk of lime shows a content in lime or dolomitic lime hydrate of 1 to 60% in weight compared to the global mass of the milk of lime;
e. the mix of a solid additive with quicklime (CaO or dolomitic lime) and slaking of the quicklime with water in such a quantity that the resulting milk of lime shows a content in lime or dolomitic lime hydrate of 1 to 60% in weight compared to the global mass of the milk of lime;
f. the impregnation of anhydrous dry hydrated lime (or dolomitic lime) with an aqueous or non-aqueous solution of a solid additive in such a quantity that the resulting milk of lime shows a content in lime or dolomitic lime hydrate of 1 to 60% in weight compared to the global mass of the milk of lime;
g. the impregnation of quicklime (CaO or dolomitic lime) with an aqueous or non-aqueous solution of a solid additive in such a quantity that the resulting milk of lime shows a content in lime or dolomitic lime hydrate of 1 to 60% in weight compared to the global mass of the milk of lime;

It has to be noted that the above mentioned weights of lime never take account of the weight of the added additives. Moreover, an additive is understood as a product used alone or as a mix.

### Example 1

This example describes the stalization of concentrated milks of lime (30% in weight of dry matter) naturally unstable in aging conditions, by the addition of additives.

The preparation protocol is the following: the additive is incorporated at a rate of 0.1 to 0.5% in dry/dry weight (i.e. quantity of active matter of additive compared to the quantity of dry matter necessary for the preparation of the milk of lime) into 1,050 g of demineralised water and thermostated at 20° C. used to prepare the suspension. The additives are selected among a glucide, a glucide modified by oxidation, a glucide modified by hydrogenation and a sulfoned derivate. The mix is homogenised by mechanical stirring during 2 min. After that, 450 g of hydrated lime is added and mechanical stirring continues for 5 min. The milks of lime prepared according to this process go through a 355 μm screen cloth. The milks of lime are measured at the start, then they are left to age for 12 h under low agitation (i.e. 200 rpm) and then measured again. They are characterized in terms of viscosity by means of a <<Haake Rotovisco RT20>> viscosimeter at a shearing speed of 5 to 100 s⁻¹ (see table I).

TABLE I

| | Viscosity measured at | | | | | | | |
|---|---|---|---|---|---|---|---|---|
| | at start | | Agitation 200 rpm | | at start | | Agitation 200 rpm | |
| | 5 s⁻¹ | 100 s⁻¹ | 5 s⁻¹ | 100 s⁻¹ | 5 s⁻¹ | 100 s⁻¹ | 5 s⁻¹ | 100 s⁻¹ |
| Without additive | 975 | 91 | 7320 | 1260 | 975 | 91 | 7320 | 1260 |
| Saccharose | 433 | 30 | 660 | 60 | 78 | 5 | 222 | 20 |
| D-gluconic Acid | 269 | 19 | 317 | 25 | 74 | 5 | 101 | 9 |
| Sorbitol | 419 | 33 | 546 | 49 | 314 | 24 | 408 | 42 |
| Lignosulfonate | 967 | 92 | 1176 | 124 | 921 | 88 | 1101 | 121 |

| | |
|---|---|
| Dosing of 0.1% in additive | Dosing of 0.5% in additive |

As foreseen, the rheological properties such as the dynamic viscosities at shearing speeds of 5 to 100 s⁻¹ of the milks of lime not treated with additives, strongly evolve in time, proving their lack of stability.

Surprisingly, the use of additives allows maintaining, whatever the static or dynamic aging conditions, the rheological properties in low levels of viscosity. It is clear that these additives maintain the stability in milks of lime.

### Example 2

This example describes the stalization of concentrated milks of lime (30% in weight of dry matter) naturally unstable in aging conditions, by the addition of additives.

The preparation protocol is identical to the one described in example 1. The milks of lime are measured at the start, then submitted to a 12-hour aging phase during which they undergo strong agitation (i.e. 600 rpm) and finally measured again.

TABLE II

| | Viscosity measured at | | | | | | | |
|---|---|---|---|---|---|---|---|---|
| | at start | | Agitation 600 rpm | | at start | | Agitation 600 rpm | |
| | 5 s⁻¹ | 100 s⁻¹ | 5 s⁻¹ | 100 s⁻¹ | 5 s⁻¹ | 100 s⁻¹ | 5 s⁻¹ | 100 s⁻¹ |
| Without additive | 975 | 91 | 7320 | 1260 | 975 | 91 | 7320 | 1260 |
| Saccharose | 433 | 30 | 881 | 76 | 78 | 5 | 195 | 15 |
| D-gluconic Acid | 269 | 19 | 425 | 32 | 74 | 5 | 99 | 7 |
| Sorbitol | 419 | 33 | 706 | 55 | 314 | 24 | 387 | 30 |
| Lignosulfonate | 967 | 92 | 3523 | 422 | 921 | 88 | 818 | 72 |

| | |
|---|---|
| Dosing of 0.1% in additive | Dosing of 0.5% in additive |

The results are shown in table II. As foreseen, the natural instable inclination of milks of lime is confirmed.

Surprisingly, the incorporation of an additive chosen among the glucides or modified glucides, maintains the rheological properties of the milk of lime.

### Example 3

The preparation protocol is the same as described in example 1. This example (see table III) shows the favourable influence of the saccharose on the stalization of the viscosity of the milks of lime presenting a content in dry matter of 30, 35 and 40%. The viscosity is measured, in this case, at a shearing speed of 5 s⁻¹.

TABLE III

| | | Viscosity | |
|---|---|---|---|
| | Saccharose | of the | Viscosity of the milk |
| Dry matter | concentration | fresh milk | of lime after 12-hour aging |
| concentration | dry/dry | of lime | under strong agitation |
| % | % | cP | cP |
| 30 | 0 | 912 | 5993 |
| 30 | 0.25 | 141 | 339 |
| 35 | 0 | 2405 | 12027 |
| 35 | 0.25 | 817 | 820 |
| 40 | 0 | 4101 | 9181 |
| 40 | 0.25 | 1304 | 1959 |

### Example 4

The preparation protocol is the same as described in example 1. This example (see table IV) compares the influence of saccharose and fructose on the stalization of the viscosity of milks of lime with a content of dry matter of 30%. The concentrations in saccharose range from 0 to 0.5%, while the concentrations in fructose range from 0 to 2%. This difference is not significant as such: it shows that for a determined type of milk of lime (composition, particulate size, dry matter content, aging conditions, etc), certain glucides (or their derivates) are more appropriate than others. In this case, the viscosity is measured at a shearing speed of 5 s⁻¹.

TABLE IV

| | | | Viscosity of |
|---|---|---|---|
| | | | the milk of |
| | Saccharose | | lime after 12-hour |
| Dry matter | concentration | Viscosity of the | aging under |
| concentration | dry/dry | fresh milk of lime | strong agitation |
| % | % | cP | cP |
| 30 | 0 | 912 | 5993 |
| 30 | 0.10 | 379 | 906 |
| 30 | 0.25 | 141 | 339 |
| 30 | 0.5 | 72 | 195 |
| 30 | 0 | 1069 | 4515 |
| 30 | 0.40 | 821 | 470 |
| 30 | 1 | 732 | 291 |
| 30 | 2 | 459 | 163 |

1-11. (canceled)

12. A process of preparing limestone lime and/or magnesium lime milk of lime suspensions presenting a stable viscosity, comprising:
adding to the suspension glucides selected from the group comprising monosaccharides, disaccharides, oligosaccharides and derivates of glucides obtained by oxidation or by hydrogenation.

13. The process according to claim 12, characterized by the fact that the milk of lime is obtained by hydration of quicklime.

14. The process according to claim 12, characterized by the fact that the milk of lime is obtained by putting slaked lime into suspension.

15. The process according to claim 12, characterized by the fact that the dry matter content of the resulting milk of lime ranges between 1 and 60% in weight.

16. The process according to claim 13, characterized by the fact that the dry matter content of the resulting milk of lime ranges between 1 and 60% in weight.

17. The process according to claim 14, characterized by the fact that the dry matter content of the resulting milk of lime ranges between 1 and 60% in weight.

18. The process according to claim 12, characterized by the fact that the content in glucides is of 0.01 to 10% in weight compared to the weight of dry matter in the milk of lime.

19. The process according to claim 12, characterized by the fact that the monosaccharides are selected from the group comprising erythrose, threose, xylose, ribose, allose, glucose, galactose, fructose and mannose.

20. The process according to claim 12, characterized by the fact that the disaccharides are selected from the group comprising sucrose, lactose, maltose and trehalose.

21. The process according to claim 12, characterized by the fact that the derivates of the glucides modified by oxidation are selected from the group comprising galacturonic acid and its salts, glucuronic acid and its salts, and gluconic acid and its salts.

22. The process according to claim 12, characterized by the fact that the derivates of the glucides modified by hydrogenation are selected from the group comprising sorbitol, erythritol, xylitol, lactitol and maltitol.

23. The process according to claim 12, characterized by the fact that the suspensions are substantially formed with water.

24. The process according to claim 12, characterized by the fact that the suspensions are substantially formed with water and a non-aqueous solvent.

25. A milk of lime suspension, having stable viscosity, containing a dry matter content of the milk of lime between 1 and 60 percent by weight, containing 0.01 to 10 percent by weight, compared to the weight of dry matter in the milk of lime of a glucide selected from the group comprising monosaccharides, disaccharides, oligosaccharides and derivates of glucides obtained by oxidation or hydrogenation.

26. A milk of lime suspension according to claim 25, characterized by the fact that the monosaccharides are selected from the group comprising erythrose, threose, xylose, ribose, allose, glucose, galactose, fructose and mannose.

27. A milk of lime suspension according to claim 25, characterized by the fact that the disaccharides are selected from the group comprising sucrose, lactose, maltose and trehalose.

28. A milk of lime suspension according to claim 25, characterized by the fact the derivates of the glucides modified by oxidation are selected from the group comprising galacturonic acid and its salts, glucuronic acid and its salts, and gluconic acid and its salts.

29. A milk of lime suspension according to claim 25, characterized by the fact the derivates of the glucides modified by hydrogenation are selected from the group comprising sorbitol, erythritol, xylitol, lactitol and maltitol.

30. A milk of lime suspension according to claim 25, characterized by the fact that the milk of lime is obtained by the hydration of quicklime.

31. A milk of lime suspension according to claim 25, characterized by the fact that the milk of lime is obtained by putting slaked lime in suspension.

32. A milk of lime suspension according to claim 25, characterized by the fact that the suspension is substantially formed with water.

33. A milk of lime suspension according to claim 25, characterized by the fact that the suspension is substantially formed with water and a non-aqueous solvent.
